(19) United States
(12) Patent Application Publication
(10) Pub. No.: US 2012/0262812 A1
(43) Pub. Date: Oct. 18, 2012

(54) TEST APPARATUS AND METHOD OF TESTING WITH A TEST APPARATUS

(75) Inventors: Ian Peter McGuire, Portchester (GB); Graham Robert Eveleigh, Rake (GB); Keith Rowland Charles Brady, Fareham (GB)

(73) Assignee: Xyratex Technology Limited, Hampshire (GB)

(21) Appl. No.: 13/369,097

(22) Filed: Feb. 8, 2012

Related U.S. Application Data
(60) Provisional application No. 61/441,827, filed on Feb. 11, 2011.

(51) Int. Cl. G11B 5/455; G11B 21/02

(52) U.S. Cl. 360/31; 360/75; G9B/21.003; G9B/5.145

(57) ABSTRACT

There is disclosed a test apparatus for performing testing with a read/write head and method of testing with a test apparatus. The test apparatus includes a head load mechanism for receiving and positioning the read/write head during testing and a multi-channel preamplifier arranged to interface plural channels to a measurement system. A first channel of the multi-channel preamplifier has a connector for connecting to the read/write head. One or more other channels of the multi-channel preamplifier is connected to or has a connector for connecting to another device for interfacing that device to the measurement system.

This application claims the benefit of priority to U.S. application Ser. No. 61/441827, filed Feb. 11, 2011, the content of which is hereby incorporated by reference.

The present invention relates to a test apparatus and to a method of testing with a test apparatus.

In embodiments, the present invention relates generally to head media test apparatus such as are commonly known as “spinstands” or “dynamic electrical test machines” in the art. Spinstands were first developed in the art as a tool for use during research and development to allow the performance of the various components of disk drives, for example the heads, disks and channels, to be evaluated and optimised. It is now common to also use spinstands in the field of disk drive manufacturing to test each manufactured read/write head or disk before it is assembled into a disk drive unit.

A typical spinstand comprises a motor-driven spindle on which a disk to be tested can be mounted and spun, and a head load mechanism for holding and positioning the read/write head to be tested. Usually, though not always, the head is incorporated into a head gimbal assembly (HGA) when it is tested. The spinstand also has a spinstand controller and a measurement system. The spinstand controller is responsible for controlling the mechanical aspects of spinstand, such as spinning up the disk, loading the head to the disk and fine positioning the head to a desired location on the disk. The measurement system (also sometimes known as a read/write analyser) is arranged to write test data with the head to a track on the disk, and subsequently to read back the test data with the head, measure and analyse the data, and display the results to the user. Additionally, dedicated parametric measurement electronics, a spectrum analyser or an oscilloscope may be provided for analysing and displaying the measurements made with the spinstand. Various parameters under which the data is written and/or read back can be controlled and varied by the measurement system, allowing the performance and characteristics of the part under test to be investigated under various conditions. In this way a series of tests may be conducted, including for example bit error rate (BER) bathtubs, track squeeze, track centre, read/write offset, overwrite, etc.

A preamplifier (or just preamp) device is connected in the signal path between the read/write head and the measurement system. This supplies appropriate drive voltages to the head when writing data and also amplifies the relatively weak signals picked up by the head when reading data to be in a form suitable for processing by the measurement system. In addition, many disk drives use fly-height control to maintain a head to media separation at a controlled distance during data write operations. Optionally, the preamplifier may have heater circuitry that can assist fly-height control by delivering a programmable constant power to a resistive heater element on a slider to generate heat to effect protrusion in the slider element.

Most known spinstands use cartridge- or block-based mechanical architectures to allow the head to be received by the spinstand. In such a scheme, a HGA is prepared for testing by being first mounted on a cartridge type device away from the spinstand, which is then in turn mounted to the spinstand. The preamplifier is also mounted to the cartridge. In mounting the HGA to the cartridge, the operator will align the HGA to the cartridge with a high precision, as well as making electrical connection between the HGA and the preamplifier. The cartridge is then mechanically and electrically attached to the spinstand and measurement system.

In other schemes, it is known to use non-cartridge-based head testing. For example, US-A-2008-0061776 entitled “Method and Apparatus for Loading a Read/Write Head to a Spinstand” co-owned by the present applicants and Seagate Technology LLC discloses an apparatus for loading a HGA to a spinstand. In such a scheme, the spinstand has a so-called “test nest” for holding the HGA for testing and a preamp board mounted adjacent the test nest. The test nest clamps the HGA and electrical connection is made to the electrical contacts of the HGA by the spinstand to connect the HGA to the preamplifier. Other examples of non-cartridge-based head testing apparatus are disclosed in WO-A-2010/127967 and WO-A-2011/048075 also co-owned by the present applicants and Seagate Technology LLC.

It is often desired to test different kinds of HGA with the same spinstand. The preamplifier device is normally a commercial off-the-shelf part which is product specific, i.e. to take account of the electrical properties of the head being tested. Typically therefore, existing spinstands use a separate preamp device for each different kind of HGA being tested, which means that swapping different heads means swapping the preamp boards. This leads to time consuming recalibration and set up of the measurement system to take account of the new preamp.

Furthermore, HGAs conventionally come in two varieties, namely an up head for testing the top of a disk platter and a down head for testing the underside of a disk platter. It is desirable to be able to test up-heads and down-heads with the spinstand with minimum or no reconfiguration of the spinstand or electronics except to swap over the heads. In this case, in the prior art, a separate preamplifier would be provided for each head. This means that external multiplexers, switches and/or splits 4 and the like must be used in the signal path to route the signals coming to and from the preamplifiers 3 to the measurement system 5. This allows one or more selected preamps 3 to be selected for use with the head 1,2 under test, for example by supplying suitable control signals to the multiplexer 4. However, this arrangement has the disadvantage of increasing the length and the number of components in the signal path between the heads 1,2 and the measurement system 5. As will be appreciated, the signals picked up by the heads 1,2 are very weak and so it is important to minimise any signal distortion or noise that might affect them. Thus it is important to keep the critical signal path as short and simple as possible by avoiding additional components in the signal path. These arrangements also lead to increased complexity in designing a test nest to accommodate the multiple preamp boards and are also expensive to implement.

It is also desirable to be able to calibrate and/or perform diagnostics on the preamp to determine the performance of the preamp and to pin down possible errors in the system. It is desirable for the apparatus to be able to perform end-to-end self testing, known as “Built In Self Test”, i.e. for the machine to be able test itself. Prior art arrangements make little provision for these functions and are generally inadequate in this respect.

According to a first aspect of the present invention, there is provided a test apparatus for performing testing with a read/write head, the test apparatus comprising:

a head load mechanism for receiving and positioning the read/write head during testing;

a multi-channel preamplifier arranged to interface plural channels to a measurement system,

wherein a first channel of the multi-channel preamplifier has a connector for connecting to the read/write head, and

one or more other channels of the multi-channel preamplifier is connected to or has a connector for connecting to another device for interfacing that device to the measurement system.

The use of a multi-channel preamplifier allows more than one device to be interfaced to the measurement system using only one preamplifier device. This minimises the components required and means no external multiplexers or splits are required in the signal path thus keeping the critical signal path short. This allows plural heads to be tested with simplified signal paths compared with prior art arrangements. The mechanical configuration is also simplified as now only one preamp board is required. This is particularly advantageous when used with spinstands having a single test nest design. This also solves a problem with the prior art of using plural preamplifiers of having the dies of the preamplifier integrated circuits offset from each other, leading to differences in the signal paths.

Using a multi-channel preamplifier also allows additional functionality compared with prior art arrangements as described below. For example, this can allow diagnostic and calibration features implemented at the head interface by utilising spare preamp channels, as well as new methods of testing.

In the prior art, if it was desired to have more than one device to be measured, for example two read/write heads, interfaced to the measurement system, this is conventionally accomplished by using a separate preamplifier for each device to be measured. The signals to and from the two preamplifiers would be combined through splitters and multiplexers and the like in the signal path before interfacing with the measurement system. This creates longer and more complicated signal paths with more components, which tends to introduce noise into the signal path and degrade the precise signals that are being used in the measurements.

In contrast, the present invention uses a multi-channel preamplifier having a channel for each measurement source. This eliminates the extra components in the signal path leading to higher fidelity in the signals. This also simplifies the design of a preamp board to hold the preamplifier and makes control of the preamplifier easier to arrange. The arrangement requires fewer preamp boards (preferably only one) and support electronics than prior art schemes and so considerably lowers the cost and complexity of manufacture.

Typically, a preamplifier for use with read write heads will be arranged to receive a data input signal from a signal source, e.g. the measurement system, and to drive the head write element on a selected channel with an appropriate current/voltage to write that data with the head. The preamplifier will also be arranged to receive a signal from the read element of a read/write head on a selected channel, to amplify the signal and to pass the amplified signal to the measurement system over a data signal output. The preamplifier may also optionally be able to supply a heater current to a heater element of a read/write head on a channel of the preamplifier.

In a preferred embodiment, the test apparatus is a test apparatus having a spindle for mounting and rotating a magnetic disk medium which can be written to and read from by the read/write head. However, other forms of media could be used and test apparatus could be used. In any event, the testing carried out by the “test apparatus” is for testing read/write heads that are not assembled into a disk drive unit, e.g. head gimbal assemblies (HGAs), etc.

In an embodiment, at least one other channel of the preamplifier has a connector for connecting to another read/write head.

This allows different heads to be tested without complicating the signal path by introducing additional preamplifiers and splitters/multiplexers in the signal path. This also allows the design of the test nest to be simplified, as only one preamp board is needed. In a preferred embodiment, an up-head and a down-head can be tested by being connected to two channels of the preamplifier. More channels of the preamplifier can be connected to heads if desired, allowing for example bank write mode testing to be performed on the heads.

In an embodiment, at least one channel of the preamplifier is connected to simulated head circuitry.

This allows the measurement system to perform calibration and diagnostics testing. The measurement system can measure the properties of the simulated head circuitry and compare these with the valued obtained from actual read/write heads when reading/writing data. This comparison can be used for diagnostics. For example, if the measured simulated head value is within expected bounds whilst the actual head value is not within expected bounds, then a determination can be made that there is likely to be a problem with the electrical connections made to the head.

The simulated heads can also be written to as part of bank mode head testing. In this mode, it is desired to simulate writing multiple heads at once so that the head under test can be tested in these operating conditions. Thus, this configuration can be used to write to a head under test together with one or more simulated heads as part of bank mode testing.

In an embodiment, the simulated head circuitry comprises a complex impedance network. This can comprises one or more resistors, capacitors and/or inductors connected in series and/or in parallel to create a network having a desired nominal measurement value, e.g. resistance or reactance. This for example allows the measurement value measured for actual heads to be compared for calibration or diagnostic testing against the measurement value measured for the simulated head.

In an embodiment, at least one channel of the preamplifier is connected or connectable to a source of a test signal.

This allows improved testing by injecting a custom test signal at a spare preamplifier channel. The signal is amplified by the preamplifier and passed to the measurement system as if it was a real signal read by the read/write head. A comparison can then be made between the actual test signal received at the measurement system and the theoretical test signal. This allows the test apparatus and/or measurement system to be calibrated. This can also allow the diagnostics. For example, if data is written by a head and subsequently read back and found to be not within expected parameters, a possible fault can be investigated by injecting a known test signal into a spare preamp channel. If the signal received by the measurement system is as expected, then this may signify that the fault is with the write channel rather than the read channel.

The test signal can be generated by any suitable means. In an embodiment, the test apparatus comprises a test signal generator circuit arranged to generate a test signal and connected to said other channel. The test signal generator circuitry can be provided by an arbitrary waveform generator, or a simpler waveform generator, such as a sine wave generator. The circuitry may be provided by a FPGA array or any other suitable circuitry. The circuit can be on the same board that holds the preamplifier, or in embodiments can be on a common interface board as described below.

In another embodiment, the preamplifier has a write data signal connector for interfacing to the measurement system for receiving data from the measurement system to be written to the read/write head, wherein the test apparatus is arranged to connect the write data signal connector to said other channel in response to a control signal received from the measurement system so that in use a test signal received from the measurement system is connected to said other channel. Preferably the preamplifier has a read data signal connector for interfacing to the measurement system for sending data to the measurement system read from the read/write head, wherein preamplifier is arranged to receive said control signal from the measurement system over the read data signal connector. Thus, in effect, the data connector between the measurement system and the preamplifier, which is normally used for sending data to be written to a head to the preamplifier and returning data read from the head, is utilised for providing a test signal to a channel of the preamplifier.

Preferably, the preamplifier will have a write data signal connector for receiving write data from the measurement system to be written to a read write head on one of the preamplifier channels and a read data signal connector for transmitting to the measurement system the amplified signal read from one of the preamplifier channels, e.g. from the read element of a read/write head. The circuitry for connecting the data signal connector to a channel of the preamplifier may be provided on a preamp board on which the preamplifier is mounted and may be any suitable logic circuitry.

In an embodiment, the preamplifier is on a preamp board, the test apparatus comprising: a memory on the preamp board for storing information relating to the preamplifier; a memory interface on the preamp board over which said information can be read.

This allows the test apparatus and/or the measurement system to be configured according to the information obtained from the memory relating to the preamplifier. It is contemplated that the memory can be read directly by the measurement system over an appropriate connection, or alternatively in a preferred embodiment the memory can be read by a common interface board that is interposed between the preamplifier and the measurement system and which passes the information to the measurement system and/or configures itself in accordance with the information. Thus, different preamplifier boards can be used with the system. This can be useful to allow different multichannel preamplifiers to be used for different types of read/write heads. The system reads the appropriate information from the memory on the preamplifier board and configures itself appropriately.

In an embodiment, the preamplifier is on a preamp board, the test apparatus comprising a common interface board, the common interface board being arranged to receive control signals from the measurement system over a control interface and to provide a configurable power supply to the preamplifier and/or to provide configurable control signals to the preamplifier such that the common interface board provides a common interface between the measurement system and the preamplifier.

In this embodiment, the common interface board configures power supply and control lines to the preamplifier board in accordance with the preamplifier being used. This means that different preamplifiers with different control and power requirements can be used, without the measurement system having to be reconfigured each time. Instead the common interface board handles translating the control signal from the measurement system to appropriate control signals to the preamplifier and supplying the required power to the preamplifier.

In an embodiment, the test apparatus comprises:

a memory on the preamp board for storing information relating to the preamplifier; and,

a memory interface on the preamp board over which said information can be read,

wherein the common interface board is operable to read information from the memory over the memory interface and pass the information to the measurement system over its control interface with the measurement system.

In an embodiment, the information stored by the memory comprises one or any combination of:

a) the connections of the preamplifier channels;

b) nominal measurement values of a simulated head attached to a preamp channel;

c) power supply requirements of the preamplifier;

d) control interface configuration of the preamplifier; and,

e) calibration data for the preamplifier.

The connection information can include the type of head on a channel, e.g. an up head or down head, whether a simulated head is connected to the channel, whether the channel is configured to receive a test signal, whether the channel has no connection, etc. The information can potentially be read by the measurement system, or by an intermediary circuit board, such as a common interface board in a preferred embodiment.

In an embodiment, the test apparatus comprises:

a memory on the preamp board for storing information relating to the preamplifier, said information including at least power requirements of the preamplifier and/or control interface configuration of the preamplifier; and,

a memory interface on the preamp board over which said information can be read,

wherein the common interface board is operable to read interface configuration of the preamplifier from the memory and to configure the control signals and/or power supply to the preamplifier in accordance with said information.

This allows the common interface card to automatically detect the type of preamplifier and so supply the correct power and/or control signals to it.

According to a second aspect of the present invention, there is provided a method of testing with a test apparatus, the method comprising:

attaching a read/write head to the test apparatus;

connecting a multi-channel preamplifier of the test apparatus to a measurement system;

connecting at least one channel of the multi-channel preamplifier to the read/write head;

connecting at least one other channel of the multi-channel preamplifier to another device; and,

testing with the test apparatus by reading and/or writing data with the read/write head under control of the measurement system.

In an embodiment, the method comprises connecting at least one other channel of the preamplifier to another read/write head of the test apparatus and testing with the test apparatus by reading and/or writing data with that read/write head under control of the measurement system.

In an embodiment, the method comprises: connecting at least one other channel of the preamplifier to another read/write head of the test apparatus or to a simulated head; and, performing bank-write testing.

In an embodiment, at least one other channel is connected to simulated head circuitry, the method comprising:

measuring the measurement value of the simulated head; and,

using the measured value in calibrating the test apparatus or measurement system or to diagnose a fault in the test apparatus or measurement system.

In an embodiment, the simulated head circuitry comprises a complex inductance network.

In an embodiment, the method comprises:

supplying a test signal to at least one other channel; and,

measuring the test signal with the measurement system to calibrate the test apparatus or measurement system or to diagnose a fault in the test apparatus or measurement system.

In an embodiment, the preamplifier is on a preamp board, the method comprising:

storing information relating to the preamplifier on a memory on the preamp board;

reading information from the memory and configuring the test apparatus or measurement system in accordance with the information.

In an embodiment, the information comprises one or any combination of:

a) the connections of the preamp channels;

b) nominal measurement values of a simulated head attached to a preamp channel;

c) power supply requirements of the preamplifier;

d) control interface configuration of the preamplifier; and,

e) calibration data for the preamplifier.

In an embodiment, the preamplifier is on a preamp board, wherein the test apparatus has a common interface board interfaced between the measurement system and the preamp board, the method comprising:

receiving information at the common interface board as to the power requirements of the preamplifier and/or control interface configuration of the preamplifier;

providing with the common interface board a power supply to the preamplifier and/or control signals to the preamplifier in accordance with said information such that the common interface board provides a common interface between the measurement system and the preamplifier.

In an embodiment, the preamp board has a memory for storing information relating to the preamplifier, the method comprising reading the information from the memory with the common interface board and passing the information to the measurement system.

In an embodiment, the memory stores information including at least power requirements of the preamplifier and/or control interface configuration of the preamplifier.

In an embodiment, the method comprises removing a tested read/write head from the test apparatus and replacing it with a new read/write head to be tested.

Embodiments of the present invention will now be described by way of example with reference to the accompanying drawings, in which:

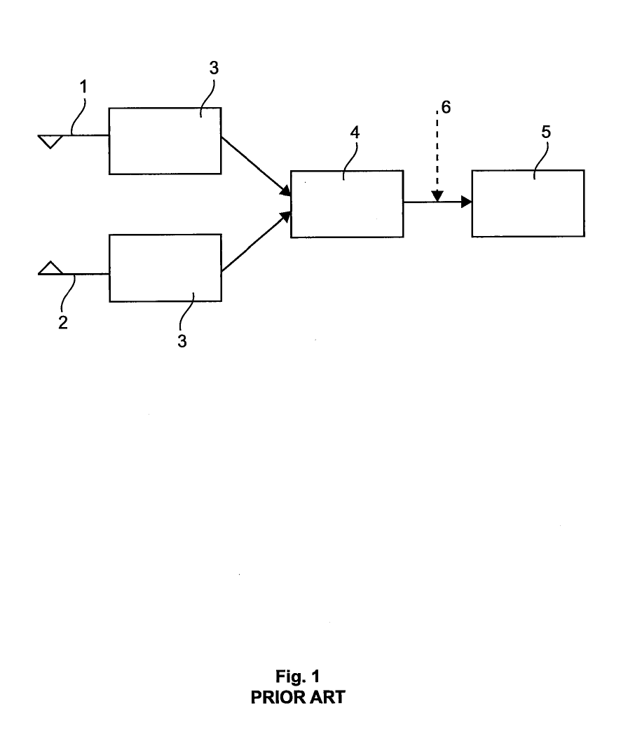

FIG. 1 shows a prior art arrangement of preamplifiers for testing multiple heads in a spinstand;

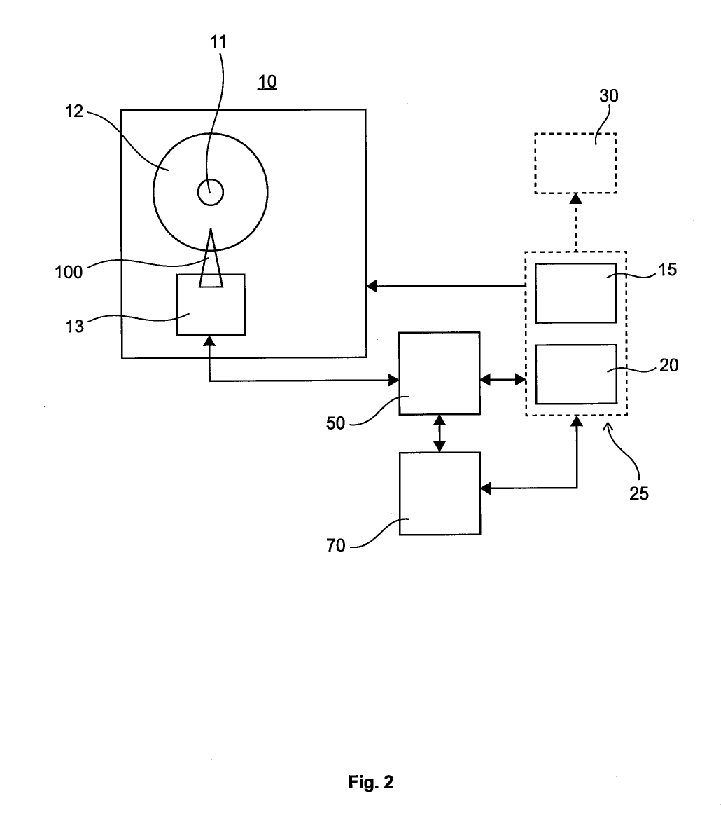

FIG. 2 shows schematically an example of a spinstand according to an embodiment of the invention; and,

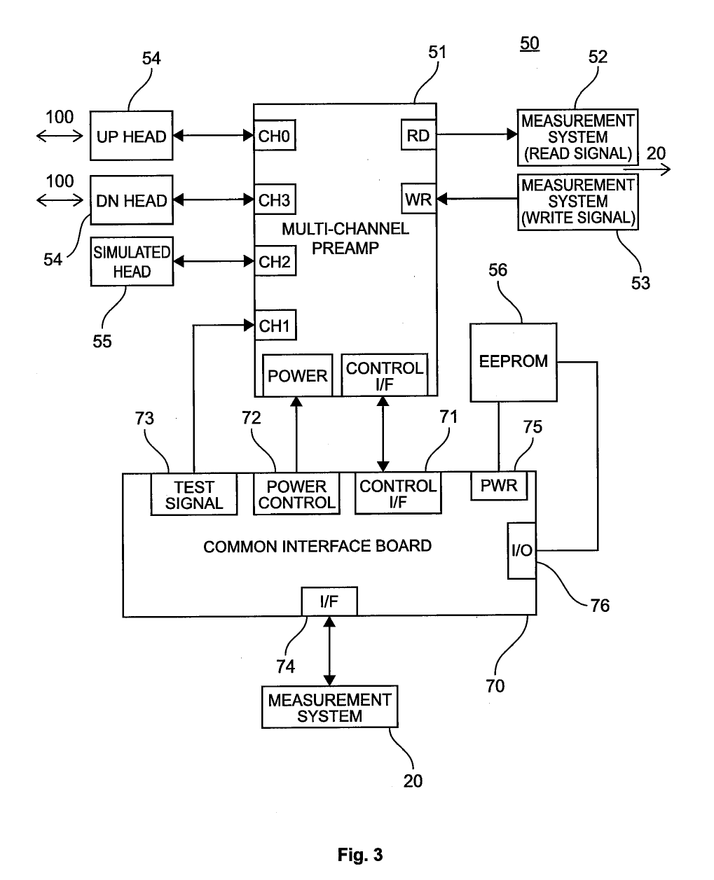

FIG. 3 shows schematically an example of a preamp board and common interface board according to an embodiment of the present invention.

FIG. 2 shows a schematic diagram of a spinstand 10. The spinstand 10 mechanically can be of any suitable known type. A preferred spinstand 10 comprises a motor-driven spindle 11 on which a disk 12 to be tested can be mounted and spun, and a head load mechanism 13 for holding and positioning the read/write head 100 to be tested. The head 100 is preferably incorporated into a head gimbal assembly (HGA) when it is tested, although other arrangements are possible. Various ways of implementing a spinstand 10 as described so far are known in the prior art, so these aspects of a spinstand will not be described in detail here.

The spinstand 10 also comprises a spinstand controller 15 and a measurement system 20. These might typically be provided by a computer 25 with appropriate expansion cards/and/or stand alone modules for the spinstand controller 15 and for the measurement system, possibly specific to whatever tests the measurement system 20 is to perform. The spinstand controller 15 is responsible for controlling the mechanical aspects of spinstand 10. These are not described in detail herein, but would consist of tasks such as spinning up/down the disk 12, loading the head 100 to the disk 12 and fine positioning the head 100 to a track on the disk 12, etc.

The measurement system 20 is arranged to write test data with the head 100 to the disk 12, and subsequently to read back the test data from the disk 12 with the head 100. A preamp board 50 is connected between the head 100 and the measurement system 20 (described in more detail below). The measurement system 20 measures and analyses the data read back from the disk 12 and displays the results to the user. Additionally, dedicated parametric measurement electronics, a spectrum analyser or an oscilloscope 30 may be provided for analysing and displaying the measurements made with the spinstand 10.

Various parameters under which the data is written and/or read back can be controlled and varied by the measurement system 20 and/or spinstand controller 15, allowing the performance and characteristics of the head 100 or disk 12 to be investigated under various conditions. In this way a series of tests may be conducted, including for example bit error rate (BER) bathtubs, track squeeze, track centre, read/write offset, overwrite, etc.

FIG. 3 shows a preamp board 50 according to an embodiment of the present invention. The preamp board 50 comprises a multi-channel preamplifier 51. In this example, the preamplifier 51 has four preamp channels (channels CH0, CH1, CH2, CH3) for connecting to read/write heads. As will be apparent in view of the following description, not every preamp channel is necessarily actually connected to a read/write head. Also, it should be noted that the preamplifier can a different plural number of channels depending on the specific application.

Each preamp channel CH0, CH1, CH2, CH3 comprises various signal lines for making connection to and from read/write heads. Typically, each preamp channel has a read signal line for reading data from the read element of the head, a write signal line for writing data to the write element of the head, and a heater signal line for driving the heater element of the head.

The preamplifier 51 provides in this example a thin film write head driver for driving the write head and TGMR read head biasing and amplification for processing the read signal. As will be appreciated, the particular parameters of the preamplifier 51 are chosen in accordance with the heads 100 being tested.

Most disk drives use fly-height control to maintain a head to media separation at a controlled distance during data write operations. Heater circuitry in the preamplifier 51 can provide fly-height control by delivering a programmable constant power to a resistive heater element on the slider of the head 100 to heat and effect protrusion in the slider. In alternative embodiments, a heater signal can be selectively supplied to the heads from an alternative source to the preamplifier 51. For example, the measurement system 20 can provide a heater signal via digital-to-analogue converters directly to the heads.

The preamplifier 51 also has a read data channel RD and a write data channel WR. The read data channel RD outputs the amplified signal from the read element of a selected head attached to one of the head channels CH0..CH3. The write data channel WR receives the write signal which is to be written to the disk by a head and drives the write element of the selected head channel CH0..CH3. The preamp board 50 has connecters 52,53 in communication with the read data channel RD and write data channel WR of the preamplifier 51 by which connection can be made to and from the measurement system 20. These might typically be MCX RF connectors or other suitable RF connectors.

Thus, the preamplifier 51 is connected between the read/write heads 100 and the measurement system 20 so as to supply appropriate drive voltages to the heads 100 when writing data and to amplify the relatively weak signals picked up by the heads 100 when reading data to be in a form suitable for processing by the measurement system 20.

In the present example, the preamp board 50 has preamp channel 0 (CH0) and preamp channel 3 (CH3) respectively connected to an up head 100 (which is used for reading/writing to the top side of a disk) and a down head 100 (which is used for reading/writing to the underside of a disk). The preamp board 50 has head connectors 54 in communication with the two channels CH0 and CH3 for connecting to the two heads 100. The head connectors 54 may comprise pogo pin blocks, i.e. spring-loaded probes, such as are known in the art per se, against which the FOS contacts of the HGA 100 can be clamped to make electrical connection between the heads 100 and the preamp board 50.

Preamp channel 1 (CH1) is connected to a test signal which injects a custom read head signal. This custom read head signal is used for preamp calibration checks and measurement system read signal path diagnostic checks. For example, system wideband and narrowband diagnostics checks may be performed. This is described in more detail in the following.

Preamp channel 2 (CH2) is connected to a simulated head circuitry 55. Preferably this circuitry 55 comprises resistors at nominal Read Head, Write Head and Heater values respectively connected to the read, write and heater signal paths on the channel. Alternatively, the circuitry on any channel could be a combination of resistors, capacitors and inductor components to form a complex impedance network. These components are preferably located on the preamp board 50 close to the preamplifier 51.

Preamp channel 2 (CH2) can then be utilised for diagnostics checks. For example, if unexpected measurements were detected at the measurement system 20, this could indicate a problem somewhere in the overall system. This could occur in various places, for example, the head, the channel, or the measurement system. A useful check to perform to help pin down the error would be to measure the measurement values, e.g. resistance and/or reactance values, on the relevant channel and compare it with the known measurement values of the heads. If the measured head value is along way from its expected value, whereas the measured simulated head value is close to its expected value, then this allows a determination to be made that for example the problem is likely to be not with the preamplifier setup or measurements system, but with the head or connections made to the head.

The preamplifier 51 also has power supply lines (POWER) on which power is supplied to the preamplifier 51 and control lines (CONTROL I/F) which are used to control the preamplifier 51.

A common interface board (CIB) 70 is provided to control the functionality of the preamp board 50. Preferably the CIB 70 is a separate board from the preamp board 50 so that it can provide a generic preamp control interface to the measurement system 20 allowing the preamplifiers 50 to be interfaced to the measurement system 20 in such a way that it is invisible to the measurement system 20 what preamplifier 51 is being used. This allows simple and fast swapping of preamp boards 50 depending on the heads being tested. The preferred CIB 70 can be used with the vast majority of current preamplifiers and, it is anticipated, with most future preamplifiers designs. As described in more detail below, the CIB 70 controls the power supplies to the preamp, provides the preamp control interface and provides the Test Signal function.

The CIB 70 preferably incorporates a FPGA or similar processor to handle logic operations and control on the board. The CIB 70 also has a communications interface 74 (such as an XBUS interface) by which it can communicate with the measurement system 20. The CIB 70 also includes a configurable logic control lines (CONTROL I/F) 71 for controlling the preamplifier 51 and configurable power supply lines (POWER CONTROL) 72 for providing appropriate power to the preamplifier 51.

To enable use of different types and configurations of multi-channel preamplifiers 51, the preamp board 50 has a memory 56, for example a serial EEPROM, which stores details of the configuration of the preamp board 50 and preamplifier 51. This might hold details of the power supply requirements of the preamplifier 51; the configuration of the control lines to the preamplifier 51, calibration data for the preamplifier 51; the connections on the channels CH0..CH3 of the preamplifier 51, i.e. whether or not each channel is connected to an up head, a down head, a simulated head 55 (i.e. a complex impedance network comprising resistors, capacitors, inductors, etc.), or a test signal input, etc.; and, the measurement value of the simulated head (i.e. resistance/reactance).

Upon start-up of the system, the measurement system 20 instructs the CIB 70, via its interface 74, to power up the EEPROM 56 via EEPROM power line 75. The configuration of the preamplifier 51 and preamp board 50 is then read by the CIB 70 from the EEPROM memory 56 via EEPROM data line 76.

The information read from the memory 56 includes the power requirements of the preamplifier 51. The power supply lines 72 are configurable to supply an appropriate voltage to the preamplifier 51. For example, different preamplifiers might use power supply rails at different voltages, e.g. 2.5V or 3V or 5V, etc. Or the preamplifier might use power supplies at different polarities, e.g. +V and GND, or +V, 0 and −V, or +V and −V, etc. In a preferred embodiment, the CIB 70 is supplied with power from a programmable power supply selected at the appropriate level or levels for the preamplifier. The CIB 70 switches power to the preamplifier 51 as required. For example, on start up, the preamplifier 51 may require the +V rail to be powered up before the −V rail. The CIB 70 switches on the power supply lines to power up the preamplifier 51 in accordance with the requirements read from the memory 56.

The information read from the memory 56 also informs the CIB 70 how to interface to the preamplifier 51 and in particular what type and form of control signals are required. This allows the CIB 70 provide a common interface to the preamp board 50 to the measurement system 20 irrespective of the particular preamp board 50 being used. The signal control lines 71 might include, for example, a read write signal to the preamplifier 50, which can be configures as a single R/W line or separate R and W lines depending on the requirements of the preamplifier 51. Other control lines 71 can be configured as general purpose analogue input and analogue output lines. Preferably, these lines can be configured for their signal level. For example, this may be accomplished by interfacing the lines to the FPGA lines via digital-to-analogue converters for the analogue inputs, and analogue-to-digital converters for the analogue outputs to convert the digital signals used at the FPGA to analogue signals for the preamplifier 51. In this way, these lines might be configurable to any suitable voltage, e.g. a voltage level anywhere between 0V and 10V or more preferably between 1.1V and 3.6V, according the function of the control line 71. Thus, by suitable control implemented by the FPGA, any manner of logic control signal can be sent to or received from the preamplifier 51. This allows just about any preamplifier 51 to be interfaced to the measurement system.

The CIB 70 can also be arranged to run calibration checks on the preamplifier 51. For example, resistance/reactance calibration data can be obtained for the up-head, down-head and simulated head, in each case for the read, write and heater elements, by comparing the raw measured value with the actual value. Similarly, other calibration can be performed, such as read voltage and current bias can be calculated for the up- and down-heads, write current calibration, heater voltage calibration, etc. These values can be stored on the EEPROM memory 56 on the preamp board 50 and downloaded during to testing to compensate for the particular characteristics of the preamplifier 51 and for the connections between the preamplifier 51 and the measurement system 20. The calibration control circuitry can be provided on the CIB 70 or on a separate board that interfaces with the CIB 70 or preamp board 50.

The CIB 70 also reads from the EEPROM memory 56 the number of preamp channels CH0..CH3 and how each is utilised, e.g. connected to an up head, or connected to a down head, or connected to a simulated head 54, or connected to a test signal 73, or not connected. This information is passed to and used by the measurement system 20 in testing. Thus, the usage of the preamp channels can be read on-the-fly and the system configured accordingly.

Where the information read from the memory 56 is that a preamp channel is connected to a simulated head, the measurement value of the simulated head, e.g. the resistance/reactance, can also be read from the memory 56 by the CIB 70. These nominal values can then be passed to the measurement system 20. The measurement system 20 can then measure the measurement values, e.g. resistance/reactance, of the simulated head and compare these with the nominal values read from the memory 56 to perform diagnostic tests. This can be done separately for each sub-channel, i.e. for a read head, a write head or a heater element.

The CIB 70 can also supply the test signal 73 to the preamplifier 51 for testing and calibration purposes. This can be any created by any suitable Arbitrary Waveform Generation circuitry on the CIB 70. For example, many FPGAs have functionality to generate an arbitrary waveform from data programmed into the FPGA. The test waveform can for example be a sinusoid of a known frequency and amplitude.

In an alternative embodiment, the preamp board 50 could be configured to receive a test signal over the measurement system write signal connector 53 and to connect this signal to the test signal input CH1 when instructed to do so in response a control signal from the measurement system 20. Preferably, in this embodiment, the control signal to “switch” the write signal to the test signal input CH1 is provided by the measurement system 20 over the measurement system read signal connector 52.

The test signal allows various diagnostics to be performed. For example, if the measured signal back from a head 100 is not within expected parameters, then there is a possible error in the system which can potentially be in any one of a number of elements of the system. For example, the problem could be in writing the test data to the disk. Alternatively, the data could be correctly written to the disk, but a problem arises in reading the data back. In this scenario, the test signal function can be used to inject a signal of known frequency or amplitude into a “spare” channel of the preamp, i.e. preamp channel 1 (CH1) in this example. This is then amplified by the preamplifier 51 as normal and passed to the measurement system 20 as if it was an actual signal picked up by a read/write head 100 from reading the disk 12. It can then be checked whether the signal at the measurement system 20 is within expected parameters and upon this a determination can be made as to whether the error is in the write circuitry or in the read circuitry in the system.

This approach differs from prior art approaches such as illustrated in FIG. 1, in which, if any provision for a test signal is made, it is injected immediately into the measurement system 20, for example into a test input of an oscilloscope used to display the test signal. This does not allow it to be determined if the problem in the system is in the read circuitry or the write circuitry. The present arrangement advantageously injects the signal further downstream so it is passed through the preamplifier 51 itself so this is a factor in the test.

In disk drive manufacturing, it is known to use “bank write mode” when servo track writing as part of formatting the head disk assembly. Modern disk drives often have more than one disk platter in order to increase data storage capacity. This means the disk drive has a plurality of read/write heads, one for each side of each platter. In servo bank write mode, when the disk/head assembly is formatted, all heads are written to at the same time to write the servo track wedges on the disks. The operating parameters of the read/write heads are different in bank write mode compared to a normal write operation. In particular, the bias current for all the read channel is not turned on during servo bank write mode as the added power dissipation for having the full read/write bias on for all heads may exceed the thermal requirements for the preamplifier. It can be useful to test the heads in this mode in a test environment before the heads are assembled into a disk drive.

The use of a multi-channel preamplifier 51 can have benefits with testing heads 100 in bank write mode. This can be simply accomplished by using a preamplifier device 51 with an appropriate number of channels to allow each head to be connected to a channel of the preamplifier 51 to allow the read/write heads to be tested in this mode. Typically, the head under test 100 would be attached to one preamplifier channel and one or more simulated heads would be attached to other preamplifier channels, and data written to them by the preamplifier in write bank mode. This allows a head to be tested in this mode of operation and achieves a more accurate representation of the operating and performance characteristics within the servo mode operation. This is something that is not practicable with prior art arrangements of having separate preamp boards for each head, where it is not possible to test heads in write bank mode using conventional techniques.

Suitable multi-channel preamplifiers are widely available commercially. Indeed, such amplifiers are sometimes used in disk drive units themselves where the disk drives can have plural heads. Despite this, no one has previously thought to use such preamplifiers in the context of a spinstand as described herein to achieve the advantages described herein.

Thus, in summary, the preferred embodiments use a multi-channel preamplifier to interface read/write heads to a measurement system to achieve a simplified signal path compared to prior art arrangements. Spare channels can be utilised to provide other functionality such as simulated heads or test signals to help with calibration and diagnostic checks.

Although the example uses a four channel preamp, preamplifiers with more channels can be used to provide additional measurement heads and/or extra simulated head circuitries with different nominal head resistance/reactance values or allow bank write mode testing by attaching simulated head models to unused channels which can be written simultaneously with the head under test.

Embodiments of the present invention have been described with particular reference to the example illustrated. However, it will be appreciated that variations and modifications may be made to the examples described within the scope of the present invention.

1. A test apparatus for performing testing with a read/write head, the test apparatus comprising:
a head load mechanism for receiving and positioning the read/write head during testing;
a multi-channel preamplifier arranged to interface plural channels to a measurement system,
wherein a first channel of the multi-channel preamplifier has a connector for connecting to the read/write head, and
one or more other channels of the multi-channel preamplifier is connected to or has a connector for connecting to another device for interfacing that device to the measurement system.

2. A test apparatus according to claim 1, wherein at least one other channel of the preamplifier has a connector for connecting to another read/write head.

3. A test apparatus according to claim 1, wherein at least one channel of the preamplifier is connected to simulated head circuitry.

4. A test apparatus according to claim 3, wherein the simulated head circuitry comprises a complex impedance network.

5. A test apparatus according to claim 1, wherein at least one channel of the preamplifier is connected or connectable to a source of a test signal.

6. A test apparatus according to claim 5, comprising a test signal generator circuit arranged to generate a test signal and connected to said other channel.

7. A test apparatus according to claim 5,
wherein the preamplifier has a write data signal connector for interfacing to the measurement system for receiving data from the measurement system to be written to the read/write head,
wherein the test apparatus is arranged to connect the write data signal connector to said other channel in response to a control signal received from the measurement system so that in use a test signal received from the measurement system is connected to said other channel.

8. A test apparatus according to claim 7, wherein the preamplifier has a read data signal connector for interfacing to the measurement system for sending data to the measurement system read from the read/write head, wherein preamplifier is arranged to receive said control signal from the measurement system over the read data signal connector.

9. A test apparatus according to claim 1, wherein the preamplifier is on a preamp board, the test apparatus comprising:
a memory on the preamp board for storing information relating to the preamplifier;
a memory interface on the preamp board over which said information can be read.

10. A test apparatus according to claim 1, wherein the preamplifier is on a preamp board, the test apparatus comprising a common interface board, the common interface board being arranged to receive control signals from the measurement system over a control interface and to provide a configurable power supply to the preamplifier and/or to provide configurable control signals to the preamplifier such that the common interface board provides a common interface between the measurement system and the preamplifier.

11. A test apparatus according to claim 10, comprising:
a memory on the preamp board for storing information relating to the preamplifier; and,
a memory interface on the preamp board over which said information can be read,
wherein the common interface board is operable to read information from the memory over the memory interface and pass the information to the measurement system over its control interface with the measurement system.

12. A test apparatus according to claim 9, wherein the information stored by the memory comprises one or any combination of:
a) the connections of the preamplifier channels;
b) nominal measurement values of a simulated head attached to a preamp channel;
c) power supply requirements of the preamplifier;
d) control interface configuration of the preamplifier; and,
e) calibration data for the preamplifier.

13. A test apparatus according to claim 10, comprising:
a memory on the preamp board for storing information relating to the preamplifier, said information including at least power requirements of the preamplifier and/or control interface configuration of the preamplifier; and,
a memory interface on the preamp board over which said information can be read,
wherein the common interface board is operable to read interface configuration of the preamplifier from the memory and to configure the control signals and/or power supply to the preamplifier in accordance with said information.

14. A method of testing with a test apparatus, the method comprising:
attaching a read/write head to the test apparatus;
connecting a multi-channel preamplifier of the test apparatus to a measurement system;
connecting at least one channel of the multi-channel preamplifier to the read/write head;
connecting at least one other channel of the multi-channel preamplifier to another device; and,
testing with the test apparatus by reading and/or writing data with the read/write head under control of the measurement system.

15. A method according to claim 14, comprising connecting at least one other channel of the preamplifier to another read/write head of the test apparatus and testing with the test apparatus by reading and/or writing data with that read/write head under control of the measurement system.

16. A method according to claim 14, comprising:
connecting at least one other channel of the preamplifier to another read/write head of the test apparatus or to a simulated head; and,
performing bank-write testing.

17. A method according to claim 14, wherein at least one other channel is connected to simulated head circuitry, the method comprising:
measuring the measurement value of the simulated head; and,
using the measured value in calibrating the test apparatus or measurement system or to diagnose a fault in the test apparatus or measurement system.

18. A method according to claim 16, wherein the simulated head circuitry comprises a complex impedance network.

19. A method according to claim 14, comprising:
supplying a test signal to at least one other channel; and,
measuring the test signal with the measurement system to calibrate the test apparatus or measurement system or to diagnose a fault in the test apparatus or measurement system.

20. A method according to claim 14, wherein the preamplifier is on a preamp board, the method comprising:
storing information relating to the preamplifier on a memory on the preamp board;
reading information from the memory and configuring the test apparatus or measurement system in accordance with the information.

21. A method according to claim 20, wherein the information comprises one or any combination of:
a) the connections of the preamp channels;
b) measurement values of a simulated head attached to a preamp channel;
c) power supply requirements of the preamplifier;
d) control interface configuration of the preamplifier; and,
e) calibration data for the preamplifier.

22. A method according to claim 14, wherein the preamplifier is on a preamp board, wherein the test apparatus has a common interface board interfaced between the measurement system and the preamp board, the method comprising:
receiving information at the common interface board as to the power requirements of the preamplifier and/or control interface configuration of the preamplifier;
providing with the common interface board a power supply to the preamplifier and/or control signals to the preamplifier in accordance with said information such that the common interface board provides a common interface between the measurement system and the preamplifier.

23. A method according to claim 22, wherein the preamp board has a memory for storing information relating to the preamplifier, the method comprising reading the information from the memory with the common interface board and passing the information to the measurement system.

24. A method according to claim 23, wherein the memory stores information including at least power requirements of the preamplifier and/or control interface configuration of the preamplifier.

25. A method according to claim 14, comprising removing a tested read/write head from the test apparatus and replacing it with a new read/write head to be tested.
